(19) United States
(12) Patent Application Publication
(10) Pub. No.: US 2007/0080021 A1
(43) Pub. Date: Apr. 12, 2007

(54) System for sounding an alarm in an escape ladder deployment system

(76) Inventor: Paula Collins, Decatur, GA (US)

Correspondence Address: Steven L. Schmid, 1824 Hickory Trace Dr., Fleming Island, FL, 32003, US

(21) Appl. No.: 11/450,910

(22) Filed: Jun. 9, 2006

Related U.S. Application Data
(60) Provisional application No. 60/725,750, filed on Oct. 12, 2005.

(51) Int. Cl. E06C 5/44

(52) U.S. Cl. 182/18

(57) ABSTRACT

Disclosed is an escape ladder deployment system wherein the deployment system is in electronic communication with an emergency detection device, central alarm system and/or additional escape ladders. The escape ladder unit includes a deployable ladder housed in a box recessed within a wall just below a window either inside or outside of a building structure. The emergency ladder unit acts in cooperation with the detection device and/or alarm system in the sounding of an alarm in event of an emergency situation.

### RELATED APPLICATION

This application relies upon U.S. Provisional Patent Application Ser. No. 60/725,750, filed Oct. 12, 2005, the contents of which are incorporated herein in their entirety.

### TECHNICAL FIELD

The present system generally relates to an alarm system and an escape ladder unit and in greater detail the system relates to an escape ladder deployment system wherein the deployment system is in communication with an emergency detection device, central alarm system and/or additional escape ladder units.

### BACKGROUND

In an emergency event the occupants of a building need a way to safely and quickly exit the building. Emergency events can include the presence of fire and dangerous gases such as carbon monoxide. Typically, occupants on the first floor of a building can safely exit through a door or window without the need for additional safety equipment. However, if an occupant is trapped on an upper floor, the only egress opening is typically though an upper story window. Given the height of the upper story window, some type of ladder or repelling device is needed to aid the occupant in escaping the distressed building. Typically, single family residential buildings lack the traditional fixed fire escapes found on most commercial and some multifamily residences such as apartment buildings and thus require some alternative means of escape.

One alternative means is to provide an escape ladder that may be deployed by an occupant of a multi-story building in an emergency. Such ladders may be constructed of rope stored in a cabinet to be deployed through a window to aid in exiting a building in an emergency. Other examples include a wire chain ladder and a collapsible ladder formed from a web material. A further example is an escape ladder having a space saving compartment containing a ladder employing wide rigid steps supported by a pair of flexible webbings strips.

Current emergency escape ladders act independently of any alarm system that may be installed within the building. One disadvantage of a stand alone emergency escape ladder is that without a central alarm system the person deploying the emergency ladder has no means of alerting others to the danger. Additionally, the person deploying the ladder may be prevented from alerting others in the building by some obstruction such as fire if no alarm has sounded. Furthermore, in a fire emergency, rooms are often filled with smoke and there is little or no available lighting making the act of locating the emergency ladder difficult. Therefore, it would be advantageous if an indication device were to be activated in an emergency indicating the location of the emergency escape ladder once the alarm system has been activated.

Thus, what is needed is a system wherein an escape ladder may be in communication with a detection device or central alarm system for sounding an alarm. Additionally what is needed is an escape ladder that may be in communication with other escape ladders.

### SUMMARY

The present system comprises a method for sounding an alarm associated with an escape ladder. The escape ladder unit is typically housed in a box recessed within the wall just below a window and is in communication with an alarm detection device, central alarm system and/or other escape ladders. The escape ladder may be located either on the interior or exterior of a building or structure. The communication is electrical in nature wherein signals may be received and sent between the ladder unit and alarm detection device, central alarm system and/or other escape ladders either wirelessly or wired. The escape ladder unit acts in cooperation with the detection device and/or alarm system in the sounding of an alarm in an emergency situation. Various methods of sounding an alarm include both sound and visual cues such as lighting.

In greater detail, the escape ladder unit may be in communication with an emergency detection device such as a smoke alarm, heat sensor, carbon monoxide sensor, sprinkler system sensor and/or other sensors used to detect an emergency event. The escape ladder may be hard wired to the detection device or connected via a wireless connection. The emergency detection device communicates with the escape ladder to trigger an event.

Events triggered by the emergency detection device include the lighting of the escape ladder, the escape ladder storage box and the lighting of certain light fixtures outside of the building. Additionally, a strobe light may be activated that indicates an emergency and/or the location of the escape ladder storage box. The emergency detection device may trigger a siren directly associated with a certain ladder unit. A general alarm located inside and/or outside the building may also be sounded. Furthermore, the detection device may signal the ladder unit to contact the authorities that an emergency situation exists at the building.

The escape ladder unit may be in communication with a central alarm system of a building. In this embodiment, information flows to and from the ladder unit. Information flowing from the ladder unit includes the ladder unit contacting the central alarm system in certain instances such as when the unit storage box has been opened or when the ladder has been deployed. Additionally, the ladder unit may contact the central alarm system when the unit box has been opened and a switch is activated by a user. Information flowing to the ladder unit includes the central alarm system contacting the ladder unit in the event of an emergency to trigger certain events such as unlocking the unit door, activating a local siren on the unit, and/or triggering lights to indicate the location of the unit.

The escape ladder units may also be networked such that the units are in communication with each other. This is typically accomplished using a master/slave configuration wherein one ladder unit acts as a control for the other units. The control unit may include a display screen or panel. The control panel may indicate when one or more ladder units have been opened or deployed. Once a ladder unit has been activated within the network, the control unit may sound an alarm selected from any one of the previously mentioned alarms including placing a call to the local authorities.

### DRAWINGS

In the drawings:

FIG. 1 is a block flow diagram illustrating the present system wherein a detection device communicates with a ladder unit to initiate certain alarm events;

FIG. 2 is a further block flow diagram depicting a central alarm unit communicating with a ladder unit and a ladder unit in communication with the central alarm to trigger certain alarm events;

FIG. 3 depicts a central control ladder unit in communication with various servant ladder units to initiate certain alarm events; and

FIG. 4 depicts a network of ladders in communication with various detection devices and with the other ladders within the network.

### DETAILED DESCRIPTION

The present system includes a system for providing an alarm event or the sounding of an alarm upon the deployment or activation of an emergency escape ladder. The escape ladder comprises a unit that typically includes a deployable ladder housed in a box recessed within a wall just below a window either inside or outside of a structure. The ladder unit is configured to be in communication with an alarm detection device, central alarm system and/or other ladder units in the sounding of an alarm in an emergency situation. Various methods of sounding an alarm include both sound and visual cues such as lighting.

The terms “sounding” and “sound” are defined to mean summon, announce and/or signal by any means, such as audio, visual and/or sensory cues, assistance in the event of an emergency. The terms “activating” or “activation” when referring to the escape ladder unit 2 includes the acts of opening of the unit, the deployment of the ladder, and/or the triggering of an alarm signaling device associated with the escape ladder unit 2. Such a signaling device may be an alarm switch.

The present system is not intended to be limited by the type or configuration of escape ladder that may be utilized with the system. The present system is directed to a networked or linked system of escape ladder units 2. The escape ladder units 2 may be in communication with or linked with a detection device 4, each other, and/or a central alarm system 6. By way of example and not by limitation, the escape ladder unit 2 may include a foldable ladder stored in a housing comprised of a box recessed within the wall just below a window on the interior or exterior of a structure. One example of a foldable escape ladder housed in a box is disclosed in U.S. Pat. No. 5,971,105, whose contents are herein incorporated in their entirety. Additionally, the escape ladder unit 2 may be configured such that the ladder portion is attached directly to the structure without the need for a housing. In a further embodiment, the ladder may be rolled out for deployment or unfolded.

The escape ladder unit 2 further comprises a communication means for receiving and/or sending signals. The escape ladder unit 2 may further comprise an apparatus for processing such signals.

The detection device 4 of the present system may be any such device capable of detecting an event. Typically, the event is one requiring immediate attention. Example devices 4 include a smoke alarm, a heat sensor, a carbon monoxide sensor, a sprinkler system sensor and/or combinations thereof.

The emergency escape ladder unit 2 triggers an event upon receiving a signal from the detection device 4. The escape ladder unit 2 may further communicate to the authorities that an emergency event has occurred. The term “authorities” is used to describe an individual or organization that may respond to an emergency call. For example, the ladder unit 2 may notify the local fire department if a detection device 4 communicates that smoke or fire has been detected.

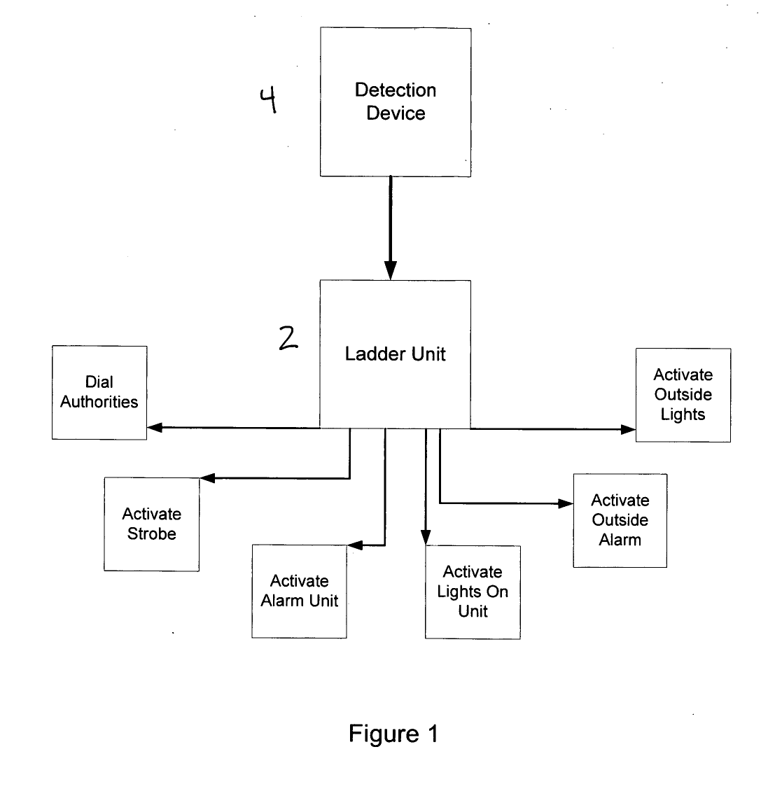

FIG. 1 illustrates the escape ladder unit 2 in communication with the detection device 4. As shown in FIG. 1, a signal is sent from a detection device 4 to the ladder unit 2 to indicate that an emergency event has occurred. Typically, the emergency event is a fire within a building. The signal may be sent either wirelessly or by wire to the ladder unit. The ladder unit 2 may have various means of receiving and processing the signal sent by the detection device 4 including by example a programmable logic controller (PLC). The ladder unit 2 processes the signal and then initiates an alarm event.

The alarm event may be any event which draws the attention of an individual or aids in the evacuation of a building. By way of example and not limitation the alarm event may be selected from the group consisting of contacting the authorities, activating a strobe light, activating a unit alarm, activating lighting associated with the unit, activating an outside alarm and/or activating outside lights.

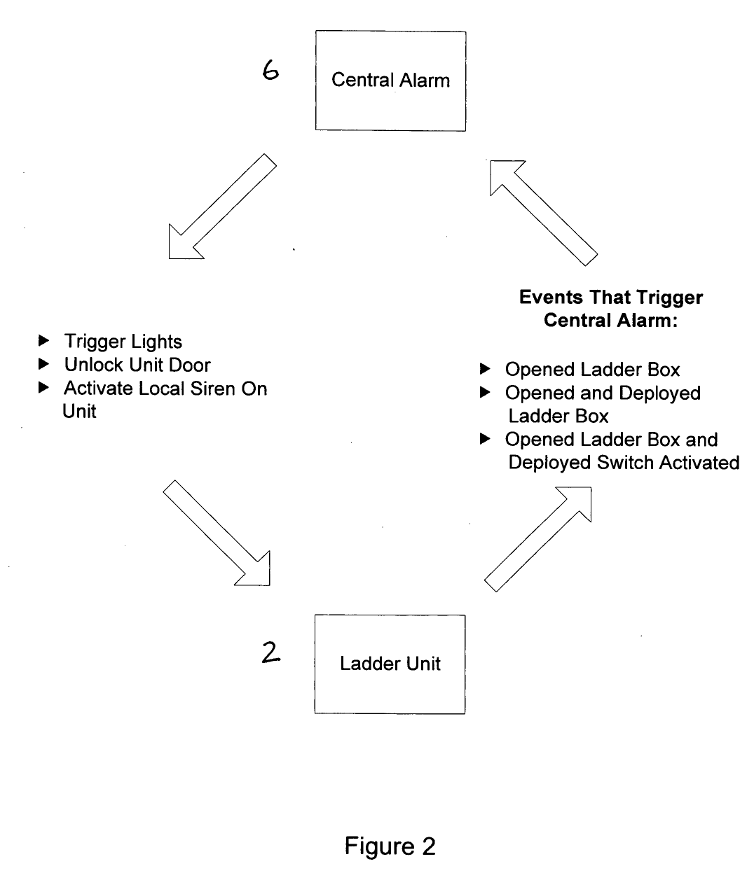

FIG. 2 depicts a central alarm system 6 in a 2-way communication with a ladder unit. The central alarm system 6 sends a signal to the ladder unit upon the occurrence of certain emergency events. The ladder unit sends a signal to the central alarm system upon certain changes in the configuration of the ladder unit.

Both the central alarm system 6 and the ladder may include a processing unit such as a programmable logic controller whereby a signal may be sent and received for processing. The central alarm system 6 detects certain events such as fire and sends a signal to the ladder unit 2 to perform certain functions. Such functions may include the triggering of lighting alarms, the unlocking of the unit door and the activation of a local siren on the unit. The ladder unit 2 also sends a signal to the central alarm system 6 upon the detection of certain changes to the configuration of the unit such as the opening of the ladder storage box, the deployment of the ladder and/or the activation of a switch located on or near the ladder unit once the ladder storage box is opened.

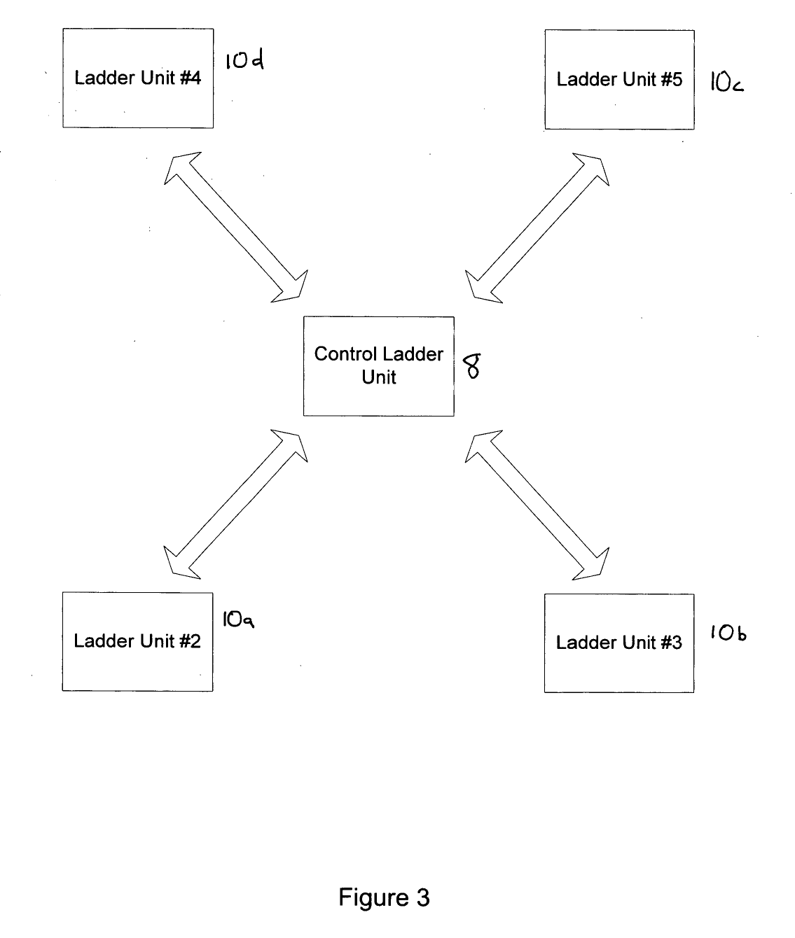

FIG. 3 depicts the master/slave relationship of the central control ladder unit 8 with various subordinate ladder units 10. The subordinate units 10(a-d) may be configured to send a signal to the central control ladder unit 8 upon the deployment or other trigger event of any of the subordinate unit ladders 10(a-d). The control unit 8 may have a display means, such as a light panel or screen for indicating the status of the subordinate units 10(a-d). Additionally, the control unit 8 may send a signal to the subordinate units 10(a-d) upon the deployment of the control unit ladder 8 or in response to a subordinate signal.

Upon the activation of a subordinate unit 10(a-d) the control unit 8 may sound a local alarm or a general alarm depending upon the settings of the control unit 8. A local alarm is useful in notifying a user upon the activation a subordinate ladder 10 without the need for sounding a general alarm. A local alarm is desired by some parents for alerting a parent that a child is seeking to leave the building without authorization or that a young child has accidentally opened a ladder storage box or deployed the ladder. The general alarm can be an exterior alarm triggered to alert neighbors and rescue workers that there is an emergency. The general alarm may also contact the authorities via a telephone connection or any other means of accepted form of communication with the authorities, such as, but not limited to, wireless, text message or radio signal. The alarms activated by the control unit may be chosen from any one of the above mentioned alarms.

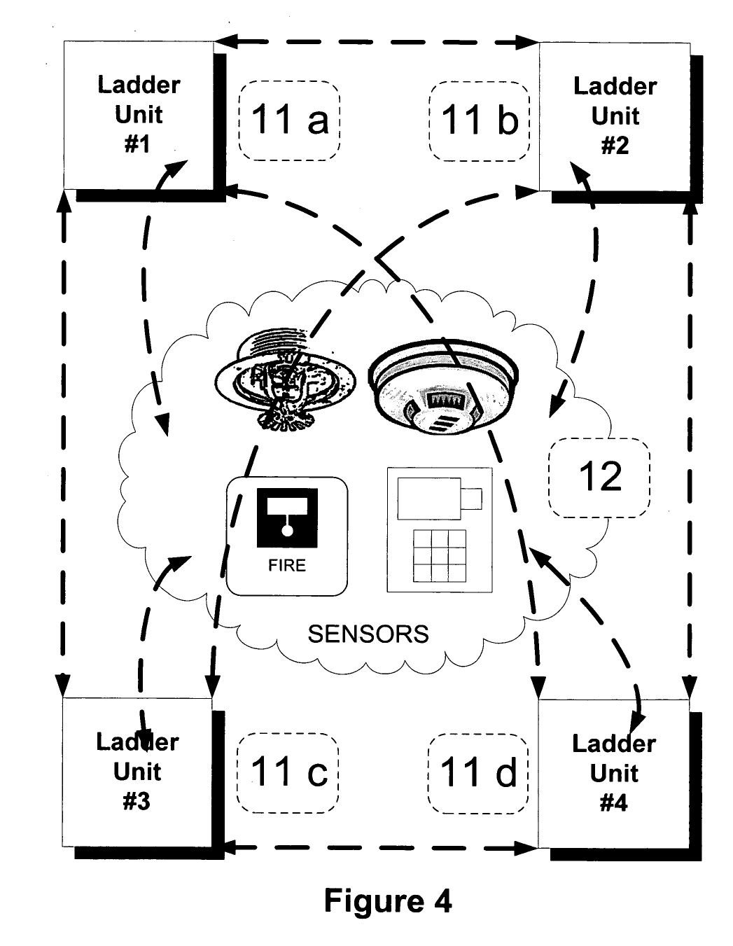

FIG. 4 depicts the relationship of a network of interconnected escape ladder units 11(a-d). As shown in FIG. 4, a signal is sent from a detection device 12 to one or more of the escape ladder units 11(a-d) to indicate that an emergency event has occurred. Typically, the emergency event is a fire within a building. The signal may be sent either wirelessly or by wire to the escape ladder unit 11. The ladder unit 11(a-d) may have various means of receiving and processing the signal sent by the detection device 12 including by example a programmable logic controller (PLC). The ladder unit 11(a-d) processes the signal and then initiates an alarm event within the network of connected ladders 11(a-d). Depending upon the settings of each unit within the network, a local or general alarm as described above would result.

In greater detail, the visual alarms may be lighting applied to the ladder storage box or lighting directed to the rungs and side supports of the deployed ladder. A light may be located on the inside of the storage box or the outside of the storage box to aid the user in seeing the room during nighttime, a smoke filled room, or aid in locating the box. Additionally, exterior lighting may be activated and directed to the path the ladder takes when the ladder is deployed.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. An escape ladder deployment system for sounding an alarm comprising:
an emergency escape ladder unit in communication with a detection device.

2. The system of claim 1, wherein the detection device is selected from the group consisting of a smoke alarm, a heat sensor, a carbon monoxide sensor, a sprinkler system sensor and combinations thereof.

3. The system of claim 1, wherein the emergency escape ladder triggers an event upon receiving a signal from the detection device.

4. The system of claim 3, wherein the event is selected from the group consisting of the lighting of a emergency ladder unit, the lighting of fixtures located outside of a building, activating a strobe light, activating a siren associated with a certain ladder unit, activating a general alarm and combinations thereof.

5. The system of claim 1, wherein the escape ladder communicates wirelessly with the detection device.

6. The system of claim 1, wherein the emergency escape ladder unit communicates with the authorities upon receiving a signal from the detection device.

7. An escape ladder deployment system for sounding an alarm comprising:
an emergency escape ladder unit in communication with a detection device wherein the detection device signals the escape ladder unit upon the detection of an emergency.

8. The system of claim 7, wherein the detection device is selected from the group consisting of a smoke alarm, a heat sensor, a carbon monoxide sensor, a sprinkler system sensor and combinations thereof.

9. The system of claim 7, wherein escape ladder unit ladder triggers an event upon receiving a signal from the detection device, wherein the event is selected from the group consisting of the lighting of an emergency ladder unit, the lighting of fixtures located outside of a building, activating a strobe light, activating a siren associated with a certain ladder unit, activating a general alarm and combinations thereof.

10. An escape ladder deployment system for sounding an alarm comprising:
an emergency escape ladder unit in communication with a central alarm.

11. The system of claim 10, wherein the emergency escape ladder unit sends a signal to the central alarm.

12. The system of claim 1 1, wherein the sent signal indicates an event selected from the group consisting of an open box trigger alarm, open and deploy trigger alarm, open and switch trigger alarm and combinations thereof.

13. The system of claim 10, wherein the emergency escape ladder unit receives a signal from a central alarm.

14. The system of claim 13, wherein the signal received from the central alarm initiates an event selected from the group consisting of triggering lights, unlocking a door of the unit, triggering an alarm on the unit and combinations thereof.

15. An escape ladder deployment system for sounding an alarm comprising:
an emergency escape ladder unit in communication with a central alarm;
the emergency escape ladder unit sending and receiving signals to and from the central alarm; and
wherein the sent signal indicates an event selected from the group consisting of an open storage box trigger alarm, open and deploy trigger alarm, open and switch trigger alarm and combinations thereof and the received signal initiates an event selected from the group consisting of triggering lights, unlocking a door of the unit, triggering an alarm on the unit and combinations thereof.

16. An escape ladder deployment system for sounding an alarm comprising:
a plurality of escape ladder units, wherein at least two escape ladder units are in communication with each other.

17. The system of claim 16, wherein the communication is wireless.

18. The system of claim 16, wherein the escape ladder units are in communication via a peer-to-peer network.

19. The system of claim 18, wherein the activation of at least one escape ladder unit is communicated to a second escape ladder unit and a local alarm is sounded.

20. The system of claim 19, wherein the activation of at least one escape ladder unit sounds a general alarm.

21. The system of claim 16, further including a master control ladder unit in communication with the escape ladder units.

22. The system of claim 21, wherein the master control ladder detects the activation of at least one of the escape ladder units and sounds an alarm.

23. The system of claim 22, wherein the alarm includes contacting the authorities and sounding a general alarm.
